(19) United States
(12) Patent Application Publication
(10) Pub. No.: US 2007/0025719 A1
(43) Pub. Date: Feb. 1, 2007

(54) Flash light reducing plate and lens-fitted photo film unit

(75) Inventor: Nobuhiko Kashiwagi, Minami-Ashigara-Shi (JP)

Correspondence Address: YOUNG & THOMPSON, 745 SOUTH 23RD STREET, 2ND FLOOR, ARLINGTON, VA, 22202, US

(73) Assignee: FUJI PHOTO FILM CO., LTD., Minami-Ashigara-Shi (JP)

(21) Appl. No.: 11/494,648

(22) Filed: Jul. 28, 2006

(30) Foreign Application Priority Data
Jul. 29, 2005 (JP) 2005-220777

(51) Int. Cl. G03B 17/02; G03B 15/03

(52) U.S. Cl. 396/164; 396/6

(57) ABSTRACT

A flash emitter includes a flash discharge tube, a reflector and a transparent protector. A light reducing plate is set in front of the flash emitter. The light reducing plate is provided with a slit located in front of a center of the long flash discharge tube, and the slit is extended in a direction perpendicular to the longitudinal direction of the flash discharge tube. The slit provides a good light distribution of flash light and reduces light to prevent overexposure of a main subject.

### FIELD OF THE INVENTION

The present invention relates to a flash light reducing plate and a lens-fitted photo film unit.

### BACKGROUND OF THE INVENTION

Various lens-fitted photo film units, in which unexposed photo films are preloaded in unit bodies, are on the market. For instance, a lens fitted photo film unit with a built-in flash device capable of photographing in a dark room or at nighttime, or a lens fitted photo film capable of close-up photography, is known. A lens-fitted photo film unit capable of photographing in a bright place and a dark place by changing over aperture value based on the photographing condition is also known.

In a close-up photography, when a photograph is taken with same amount of flash light as normal photography, the photograph is overexposed since the light amount is too large. Also in a photography in a dark room or at nighttime with a large aperture (small aperture value) for improving descriptiveness of background, when a photograph is taken with same amount of flash light as the normal photography, a main subject in the photograph is overexposed since light amount is too large.

As a prior art of reducing flash light, there is a method of using a milky-white light diffusing plate in front of a flash emitter. For example, JP-A 2004-226744 discloses that a light reducing plate provided with multiple openings is disposed in front of a flash emitter. Since the openings are regularly arranged, there occurs less unevenness of light distribution of flash light.

JP-A 2004-061536 discloses that a long and thin light shielding plate extended along a longitudinal direction of a flash discharge tube is disposed in front of a flash emitter. Flash light emitted from the central portion of the flash emitter is shielded by the light shielding plate and flash light emitted from above and below of the flash emitter is illuminated, so an appropriate pattern of light distribution is obtained. JP-A 2004-151571 discloses a light reducing plate similar to that of JP-A 2004-061536. In the light reducing plate, the both end portions in the longitudinal direction are narrower than the central portion and at least one opening is provided, therefore more appropriate pattern of light distribution can be obtained.

JP-A 11-295788 discloses that a photo chromic member which changes light transmission amount according to extraneous light stimulus is provided in front of a flash emitter. When a photograph is taken, for example, outdoors in sunny days, transmissivity of the photo chromic member becomes lower by sunlight to allow lower amount of flash light passing thorough to a subject.

JP-A 2003-098580 discloses a flash device including a liquid crystal plate disposed in front of a flash discharge tube for changing light transmission amount of flash light, and a projection lens for projecting flash light reduced by the liquid crystal plate to a subject. When a photograph is taken in a manner that a main subject is in a close-up range, transmissivity of a part of liquid crystal plate corresponding to the main subject is lowered and position of the projection lens is adjusted so that focal point of flash light coincides with the main subject to obtain most suitable exposure regardless of the position and shape of the main subject.

However, it is difficult to reduce flash light largely, especially to obtain light reducing performance of at least 3,0 EV when the milky-white light diffusing plate is used. Also in the method to use the light reducing plate provided with multiple openings as disclosed in JP-A 2004-226744, light projected from each opening interferes, therefore it is also difficult to reduce light largely. In the method to use the long and thin light shielding plate disposed along the longitudinal direction of the flash discharge tube as disclosed in JP-A 2004-061536 and JP-A 2004-151571, when light is largely reduced by broadening the width of the light shielding plate, there becomes a problem that a dark space occurs in a frame corresponding to a blocking range of the flash light blocked by the light shielding plate. In the method to use the light reducing plate provided with openings for preventing occurrence of the dark space as disclosed in JP-A 2004-151571, it is hard to obtain sufficient light reducing performance. To produce a lens-fitted photo film unit provided with both of the milky-white light diffusing plate and the various types of the light reducing plates, the number of parts and the manufacturing cost increase.

To use the photo chromic member which changes transmissivity based on extraneous light stimulus and the liquid crystal which changes transmission density by electric signal such as in JP-A 11-295788 and JP-A 2003-098580, the number of parts and the manufacturing cost increase since the materials are costly and a circuit for driving liquid crystal is further required. It is particularly difficult to employ them in the lens-fitted photo film unit characterized by inexpensive price.

### SUMMARY OF THE INVENTION

An object of the present invention is to provide a flash light reducing plate and a lens-fitted photo film unit capable of largely reducing light with providing excellent light distribution of flash light.

To achieve the above object and other objects, a flash light reducing plate of the present invention includes a plate member having light shielding effect to shield flash light emitted from a flash emitter, disposed at a front of the flash emitter, and a slit provided on the plate member through which the flash light passes. The slit is orthogonal to a longitudinal direction of a flash discharge tube in front of a center of the flash discharge tube. Both end portions of the slit in a direction perpendicular to the longitudinal direction of the flash discharge tube is desirably wider than the central portion thereof and an amount of the flash light is desirably reduced to equivalent of equal to more than 3.0 EV. An auxiliary opening for allowing passage of smaller amount of light than that of the slit may be provided on the plate member. The flash light reducing plate may be adhered to a surface of a protector by adhesive.

The flash light reducing plate is movable between a light reducing position to be positioned in front of the flash emitter and a retreat position to be retreated from in front of the flash emitter. An opening width of the slit may be adjustable.

A lens-fitted photo film unit of the present invention is provided with an external operation member which selects one of a normal mode which does not reduce flash light and a light reducing mode which reduces flash light, and a moving mechanism for moving a flash light reducing plate interlocking with selection of the light reducing mode.

One embodiment of the lens-fitted photo film unit includes a body base for containing a photo film and attached taking mechanisms. A front cover is attached to a front face of the body base. The flash light reducing plate is integrally provided to the front cover facing the flash emitter. In another embodiment of the lens-fitted photo film unit, a flash light reducing plate is provided with a slit shifted toward a taking lens from the center of said flash discharge tube to almost coincide an image taking field of a taking lens with an exposure range of flash light.

According to the present invention, sufficient light reducing performance equivalent of, for example, 1.0 EV to 5.0 EV is obtained from a small number of parts. Moreover, even when light amount is reduced to equal to more than 2.0 EV, light distribution equivalent of normal flash emission without the light reduction can be obtained.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a perspective view illustrating a lens-fitted photo film unit set in a first photography mode;

FIG. 2 is a perspective view illustrating the lens-fitted photo film unit set in a second photography mode;

FIG. 3 is a perspective view illustrating the lens-fitted photo film unit set in a third photography mode;

FIG. 4 is an exploded perspective view illustrating the lens-fitted photo film unit;

FIG. 5 is an explanatory view illustrating a composition of a mode shifting mechanism;

FIG. 6 is an exploded perspective view illustrating a flash emitter and a slide member;

FIG. 7 is an explanatory view illustrating a positional relation of a slit and a flash discharge tube;

FIG. 8 is a graph illustrating a relation of an opening width of the slit and guide number;

FIG. 9 is a sectional view illustrating a cross-sectional shape of the slit;

FIG. 10 is an explanatory view illustrating an example in which the slit is shifted toward a taking lens from a center of the flash discharge tube;

FIG. 11 is a perspective view illustrating an embodiment in which a light reducing plate is provided in a close-up adaptor, in a state that the close-up adaptor is set in a retreat position;

FIG. 12 is a perspective view illustrating the embodiment shown in FIG. 11 in a state that the close-up adaptor is set in a set position;

FIG. 13 is a perspective view illustrating an embodiment in which a light reducing plate is integrally provided on a front cover;

FIG. 14 is a front view illustrating an embodiment in which a light reducing plate is integrally provided on a backing plate which slidably holds an operation member;

FIG. 15 is a perspective view illustrating the backing plate and the light reducing plate;

FIG. 16 is a sectional view illustrating an embodiment in which a light reducing plate is a sticker;

FIG. 17 is an exploded perspective view illustrating the light reducing plate and a protector;

FIG. 18 is an explanatory view illustrating an embodiment in which an opening width of a slit is changeable;

FIG. 19 is an explanatory view illustrating an embodiment in which a slit is tilted;

FIG. 20 is an explanatory view illustrating an embodiment in which a slit is curved;

FIG. 21 is an explanatory view illustrating an embodiment in which the both end portions of a slit is wider than a center part thereof; and

FIG. 22 is an explanatory view illustrating an embodiment in which auxiliary openings are provided on a light reducing plate.

### DESCRIPTION OF THE PREFERRED EMBODIMENTS

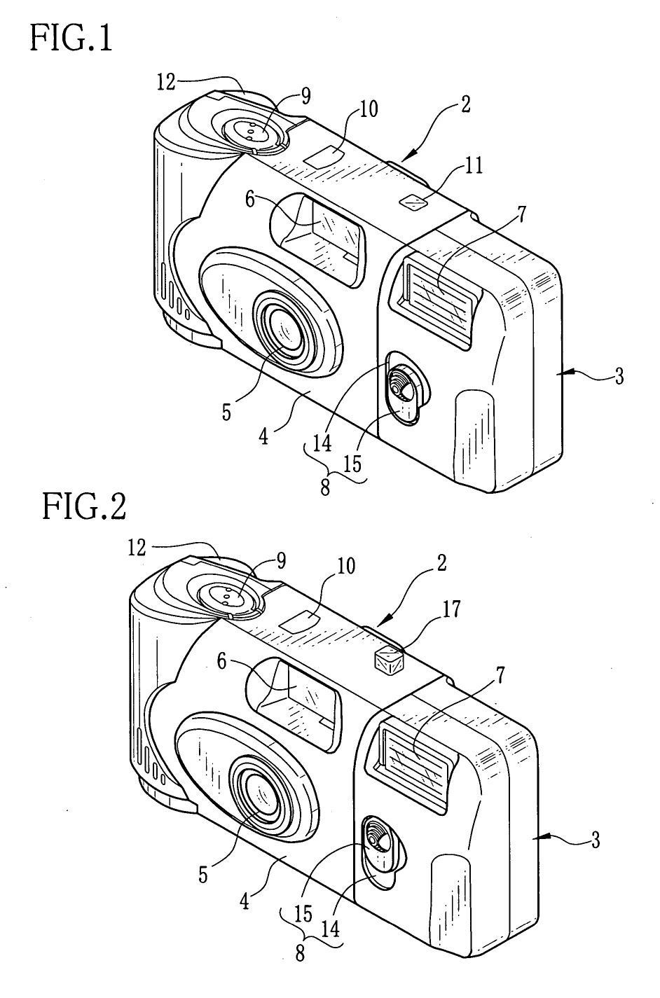

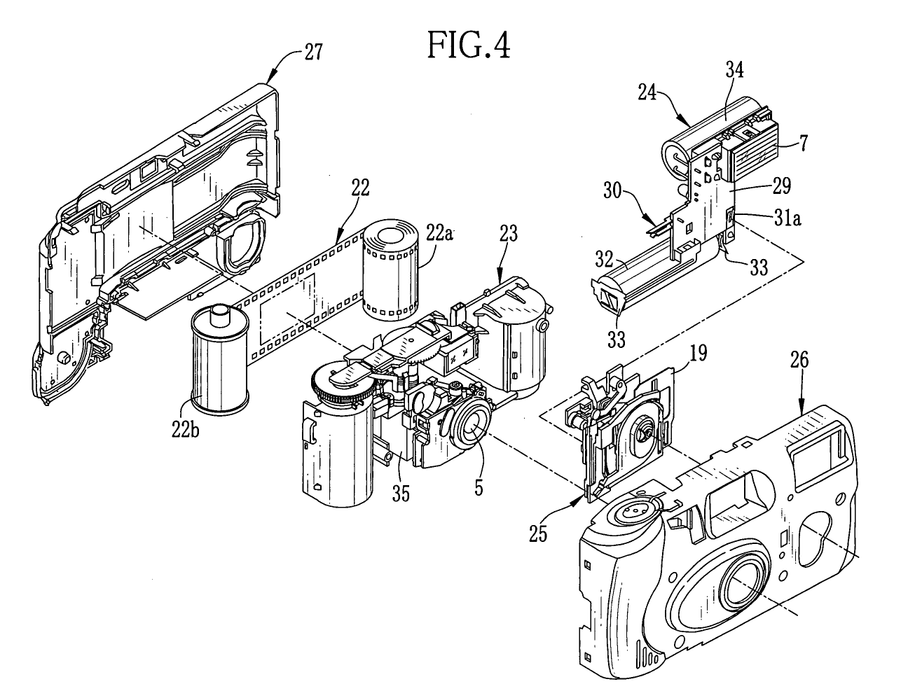

In FIGS. 1 to 3, a lens-fitted photo film unit 2 comprises a unit body 3 with built-in various photographic mechanisms, a film cartridge 22 (see FIG. 4) loaded in the unit body 3 in the factory and a label 4 pasted to wrap around an outer circumference of the unit body 3. The label 4 has openings to expose some parts of the unit body 3.

A front face of the unit body 3 is provided with a taking lens 5, a viewfinder 6, a flash emitter 7 and a photography mode selector 8 and so on. An upper face of the unit body 3 is provided with a release button 9, a counter window 10 and a signal opening 11. A film winding wheel 12 partially exposes from a back of the unit body 3.

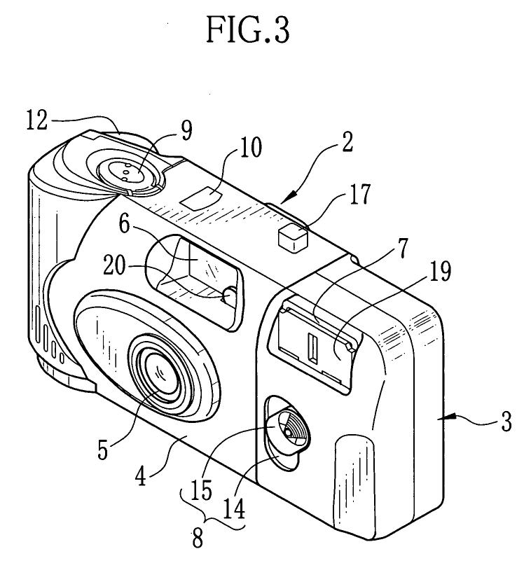

The photography mode selector 8 includes an operation opening 14 formed on the front face of the unit body 3 and an almost oval operation member 15 which is movable in the operation opening 14. The operation member 15 moves among a first operational position (see FIG. 1) located lower in the operation opening 14, a second operational position (see FIG. 2) slid upward from the first operational position and a third operational position (see FIG. 3) turned clockwise from the second operational position.

When the operation member 15 is in the first operational position, the lens-fitted photo film unit 2 is set in a first photography mode whose conditions are a small aperture and a high shutter speed without emission of flash light and are suitable for photography in a bright place such as outdoors. When the operation member 15 is in the second operational position, the lens-fitted photo film unit 2 is set in a second photography mode whose conditions are a small aperture and a high shutter speed with emission of flash light and are suitable for photography against the sun in a bright place such as outdoors. In the second photography mode, a signaling member 17 is protruded from the top face of the lens-fitted photo film unit 2. The signaling member 17 is a light guide that guides light from a light-emitting element, which is emitted on completion of charging a flash discharge tube and discharges the light from a tip thereof to inform completion of preparation for photographing.

When the operation member 15 is in the third operational position, the lens-fitted photo film unit 2 is in a third photography mode whose conditions are a large stop and a low shutter speed with emission of flash light are appropriate for photography such as outdoors at night time or indoors. In the third photography mode, the large aperture and the low shutter speed are set for photographing a dark background where flash light is not effective. A light reducing plate 19 (a flash light reducing plate) for reducing flash light is set in front of the flash emitter 7 when the operation member 15 is moved to the third operational position, in order to emit appropriate amount of flash light with a large aperture to a main subject and to reduce difference of brightness between the main subject and the background. An indication plate 20 is disposed in front of the viewfinder 6. To make a visual confirmation of the indication plate 20 in the viewfinder 6 enables a photographer to know that the lens-fitted photo film unit 2 is in the third photography mode.

In this embodiment, the second photography mode is a normal mode to emit flash light from the flash emitter without light reduction, and the third photography mode is a light-reducing mode to emit flash light with light-reduction.

Table 1 shows an example of a combination of a shutter speed and aperture value in each photography mode. According to this example, the high shutter speed and the low shutter speed are respectively set to 1/140 and 1/45 seconds, and the small aperture and the large aperture are respectively set to f/14 and f/5.6. The guide number is normally 8.8 (ISO100·m) and is reduced to 2.7(ISO100·m) when the light reducing plate 19 reduces flash light.

TABLE 1

| | | SHUTTER | | LIGHT | GUIDE |
|---|---|---|---|---|---|
| | APERTURE | SPEED | | REDUCING | NUMBER |
| | VALUE | (Sec) | FLASH | PLATE | (ISO100 · m) |
| 1st PHOTOGRAPHY MODE | f/14 | 1/140 | OFF | NO | — |
| 2nd PHOTOGRAPHY MODE | f/14 | 1/140 | ON | NO | 8.8 |
| 3rd PHOTOGRAPHY MODE | f/5.6 | 1/45 | ON | YES | 2.7 |

In FIG. 4, the unit body 3 includes a body base 23 loaded with a photo film cartridge 22, a flash device 24, a mode switching mechanism 25, a front cover 26 and a rear cover 27. Photographing mechanism, the flash device 24 and the mode switching mechanism 25 are assembled to a front side of the body base 23 and the front cover 26 is attached to the front side of the body base 23 to cover them. The rear cover 27 is attached to a rear side of the body base 23.

The 135 type film cartridge 22 is used and includes a photo film 22a and a cartridge 22b. The film sensitivity of the photo film 22a of ISO 800 or 1600, preferably 1900 or above is used. The photo film 22a is not limited to 135 type film.

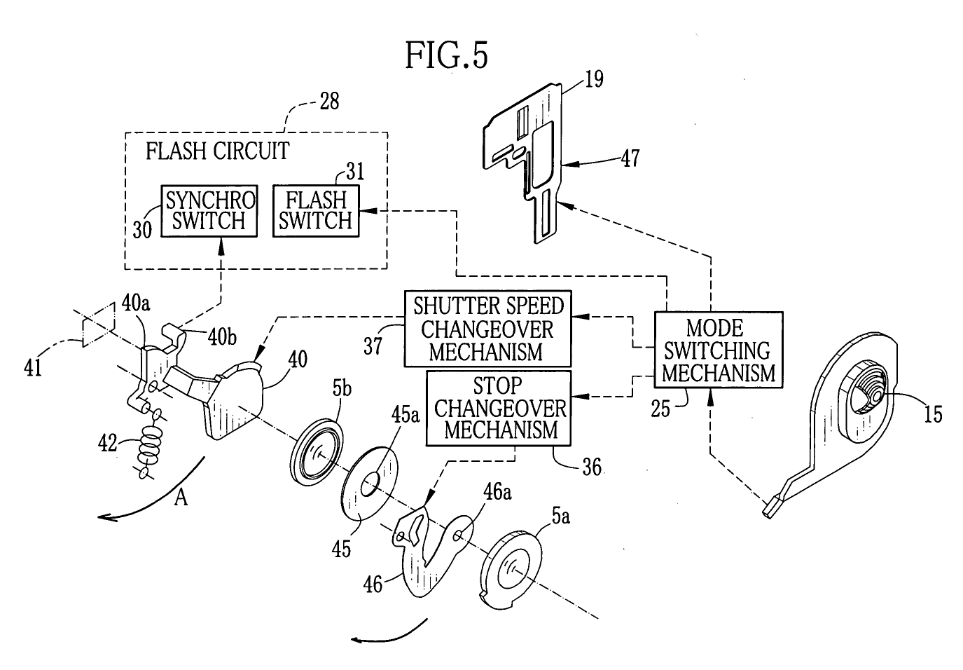

The flash device 24 is constituted of a printed circuit board 29 formed with a flash circuit 28 (see FIG. 5) and the flash emitter 7 including the flash discharge tube, a reflector and a diffusing plate. The printed circuit board 29 is provided with a synchro switch 30 which turns on in synchronism with opening and closing of a shutter blade to emit flash light, a metal contact 31a constituting a flash switch 31 (see FIG. 5) which turns on when the operation member 15 is set in the second or third operational position, a battery contact 33 connecting a battery 32 with the flash circuit 28 and a main capacitor 34 and so on.

When the flash switch 31 is turned on, charging for flash light emission is conducted. When the charging has been a completed, flash light is emitted from the flash emitter 7 immediately after the synchro switch 30 is turned on. When the flash switch 31 is turned off, charging is stopped to inhibit the flash light emission, and the flash light is not emitted even when the synchro switch 30 is turned on.

A light-shielding barrel 35 is provided at a front center of the body base 23. Various components are disposed on a periphery of the light-shielding barrel 35, such as a shutter charging mechanism, a shutter device, a film winding mechanism, a film winding stopper mechanism, a frame counter mechanism, a photographic optical system, a viewfinder optical system, a stop changeover mechanism 36 and a shutter speed changeover mechanism 37 (see FIG. 5).

As shown in FIG. 5, the mode switching mechanism 25 interlocks the flash switch 31, the stop changeover mechanism 36 and the shutter speed changeover mechanism 37 with the operation member 15. Additionally, the mode switching mechanism 25 interlocks the light reducing plate 19 and the indication plate 20 with the flash operation member 15 to insert and remove the light reducing plate 19 to and from in front of the flash emitter 7, and to insert and remove the indication plate 20 to and from in front of the viewfinder 6. The flash switch 31 is turned on by the mode switching mechanism 25 when the operation member 15 is set in the second or third operational position.

The shutter blade 40 swings in a clockwise direction (“A” direction) against bias of a spring 42 from a close position to cover a shutter opening 41 provided on a front face of the light-shielding barrel 35 when a contact portion 40a is kicked by a shutter drive lever (not shown) which rapidly moves responsive to pressing operation of the release button 9. When the shutter opening 41 is fully opened during rotation of the shutter blade 40, the synchro switch 30 of the flash circuit 28 is pressed by a press portion 40b to be turned on.

The shutter speed changeover mechanism 37 changes shutter speed, for example, by changing rotational angle of the shutter blade 40. When the operation member 15 is at the third operational position, the shutter speed changeover mechanism 37 does not restrict the movement of the shutter blade 40. In this case, the shutter blade 40 is returned to the close position by bias of the spring 42 after reaching the predetermined rotation end position. When the operation member 15 is at the first or second position, the shutter speed changeover mechanism 37 restricts the rotational angle of the shutter blade 40 so as to return the shutter blade 40 to the close position before reaching the rotation end position. Thereby, the shutter speed is high in the first or second photography mode since return of the shutter blade starts earlier. On the other hand, the shutter speed is low in the third photography mode.

The taking lens 5 constituted of a front lens 5a and a rear lens 5b, between which a fixed stop plate 45 is disposed. A large stop aperture 45a is formed in the fixed stop plate 45. A small stop aperture 46a smaller than the large stop aperture 45a is formed at an end of a movable stop plate 46 which is a part of the stop changeover mechanism 36. The movable stop plate 46 is rotatable between an insertion position where the small stop aperture 46a is disposed on the optical axis of the taking lens 5 and a retreat position where the small stop aperture 46a is retreated from the optical axis of the taking lens 5.

When the operation member 15 is at the first or second position, the movable stop plate 46 is set in the insertion position by the stop changeover mechanism 36. When the movable stop plate 46 is set in the insertion position, the large stop aperture 45a and the small stop aperture 46a are disposed on the optical axis of the taking lens 5, so the photograph is taken in a manner that light amount is limited by the small stop aperture 46a. When the operation member 15 is at the third position, the movable stop plate 46 is set in the retreat position by the stop changeover mechanism 36. When the movable stop plate 46 is set in the retreat position, only the large stop aperture 45a is disposed on the optical axis of the taking lens 5, so the photograph is taken in a manner that light amount is limited by the large stop aperture.

The light reducing plate 19 is integrally provided in an upper portion of a slide member 47. The mode switching mechanism 25 slides the slide member 47 in a perpendicular direction interlocking with move of the operation member 15 between the second operational position and third operational position. In response to the slide of the slide member 47 in the perpendicular direction, the light reducing plate 19 slides between a light reducing position to be disposed in front of the flash emitter 7 and a retreat position to be retreated from in front of the flash emitter 7. Therefore, the light reducing plate 19 is set in the retreat position in the first or second photography mode, and is set in the light reducing position in the third photography mode.

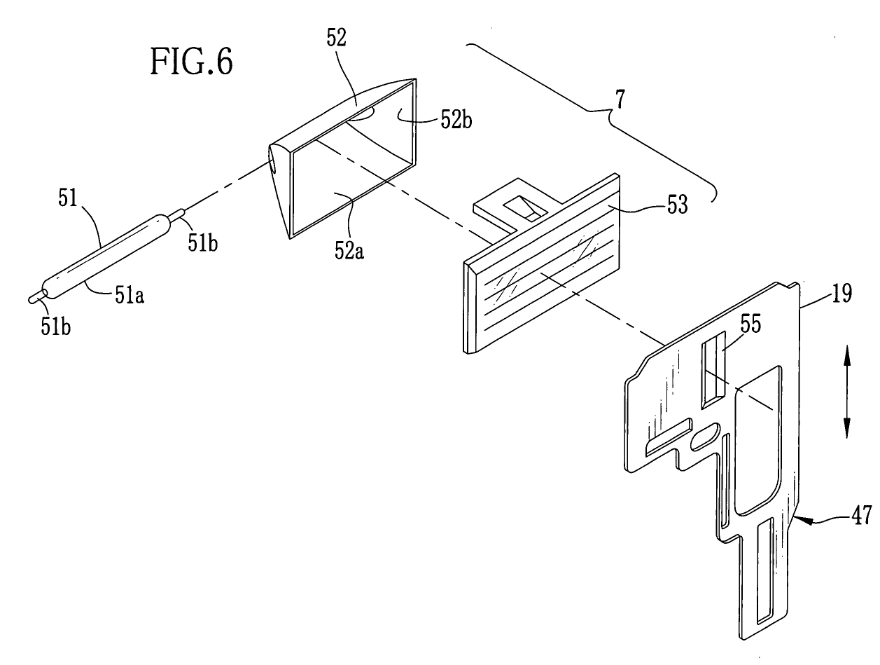

In FIG. 6, the flash emitter 7 includes a flash discharge tube 51 for discharging flash light, a reflector 52 for reflecting flash light from the flash discharge tube 51 forward, and a transparent protector 53 for protecting the flash discharge tube 51 and the reflector 52. The flash discharge tube 51 is a long and thin tube, and is attached to the reflector 52 so that the longitudinal direction of the flash discharge tube 51 (direction along the shaft) coincides with the longitudinal direction of a shooting screen of the photo film.

For example, a xenon tube which emits flash light by internal discharge is used for the flash discharge tube 51, in which an electrodes 51b for applying high voltage between them are provided at the both end portions of a discharge tube body 51a having a circular tube shape. For using flash light in photographing, light as the flash light is emitted from the discharge tube body 51a.

The reflector 52 includes a curved reflective surface 52a having a shape of “U” and disposed parallel to a peripheral surface of the flash discharge tube 51 and a tabular side reflective portion 52b provided in the vicinity of the both end portions of the flash discharge tube 51 to cover the both sides of the curved reflective surface 52a. The protector 53 is attached to the reflector 52 to cover a rectangular opening in a front side of the reflector 52 and is exposed from the front face of the unit body 2.

The light reducing plate 19 is a light-shielding plate having a size almost equal to or larger than the protector 53, with a slit 55 formed thereon for emitting flash light. When the light reducing plate 19 is set in the light reducing position, the flash emitter 7 (the protector 53) is covered by the light reducing plate 19. Only flash light emitted from the flash emitter 7 and passing through the slit 55 illuminates the subject.

It is noted that there are openings on the light reducing plate 19 for allowing passage of flash light in addition to the slit 55, but there is no influence on pattern of light distribution since almost of the light emitted from the openings is much less than that emitted from the slit 55.

Various materials having light shielding effect and low influence on color temperature of flash light can be used for the light reducing plate 19. For example, the light reducing plate 19 may be made by molding an opaque plastic material having light blocking effect or may be made by stamping a metal plate. Since the role of the slit 55 is to pass flash light, the slit 55 may be composed of a transparent plastic or glass. For example, the light reducing plate 19 may be made by coating paint or pasting a sticker on a surface of a transparent plastic except for the part of the slit. It is noted that the plastic may include a silicone. It is desirable to color the light reducing plate 19 achromatic colors such as gray or black considering that flash light reflected on a protector side surface of the light reducing plate 19 is reflected on the reflector 52 again to be emitted from the slit 55.

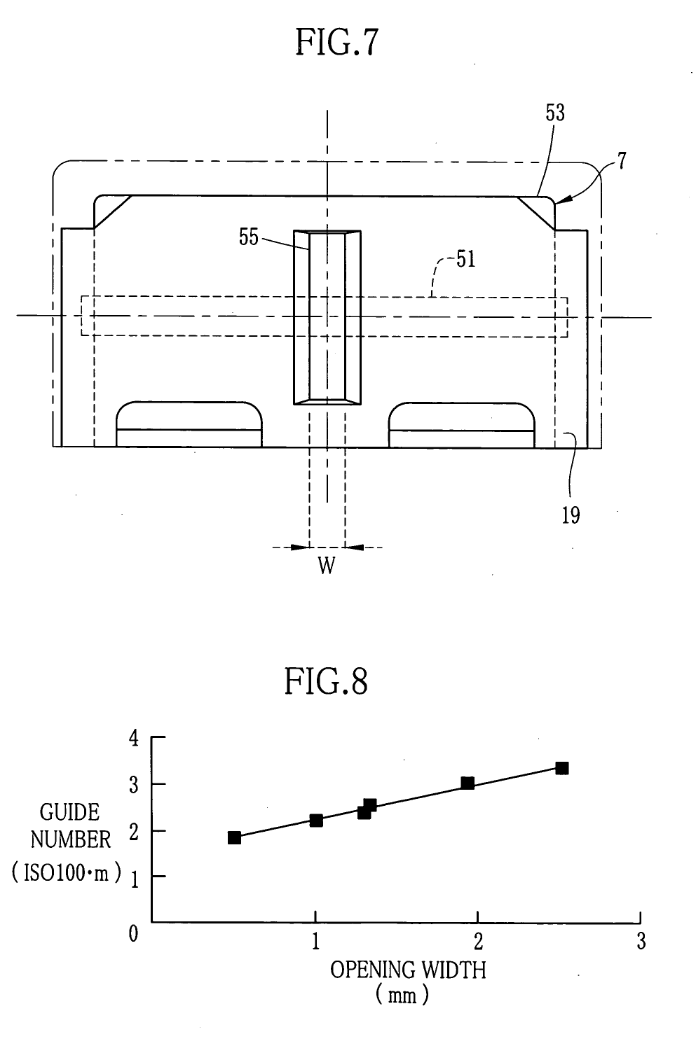

In FIG. 7, the slit 55 is disposed in front of the central part of the flash discharge tube 51 and has a long and thin rectangular shape which is perpendicular to the longitudinal direction of the flash discharge tube 51. When a light reducing plate formed with a circular opening is disposed in front of the flash emitter such that an image of the flash discharge tube is produced by principle of a pinhole camera, flash light spreads to be enormously long ellipse in the longitudinal direction of the flash discharge tube. In consideration of the problem, in the present invention, a long slit is provided on the light reducing plate to cross the longitudinal direction of the flash discharge tube at an appropriate angle, so flash light also spreads to a direction perpendicular to the longitudinal direction of the flash discharge tube, with a prefer pattern of light distribution. It is preferable that the slit is long and is provided in the direction perpendicular to the longitudinal direction of the flash discharge tube 51 as described in the above embodiment.

It is preferable that the slit 55 is located in front of the center of the flash discharge tube 51 in the longitudinal direction so that the centerline of the slit 55 crosses the flash discharge tube 51 at a point within a range of approximately 1 mm from the center. When the centerline of the slit 55 crosses the flash discharge tube 51 at a point over approximately 1 mm from the center, the exposure range of flash light is of f to the side.

The desired flash light amount (guide number) can be obtained by changing opening width “W” of the slit 55. In the light reducing plate 19 having the slit 55, the opening width “W” narrowed to 0.4 mm is enough to ensure spread of flash light in the lateral direction from characteristic of light, and if the light amount of flash light is reduced to approximately 5.0 EV, a pattern of light distribution is not damaged. As shown in FIG. 8, since there is a linearly proportionate relationship between the opening width of the center of the slit 55 (same width as the opening width “W” in this embodiment) and the flash light amount, the adjustment of the flash light amount is easy.

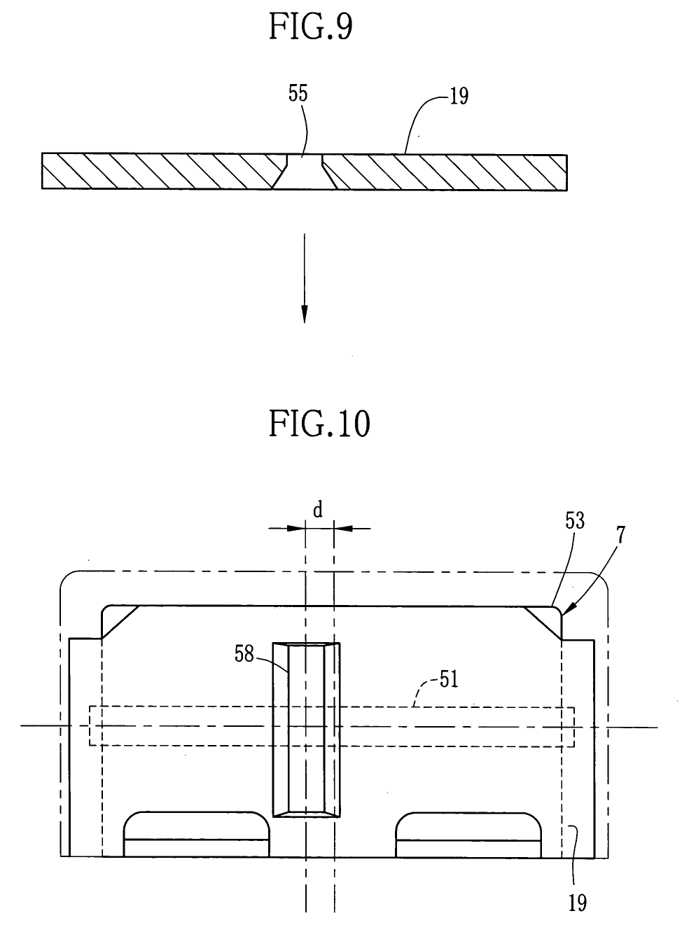

In this example, the opening width “W” is adjusted to reduce light amount to guide number 2.7 from guide number 8.8, thereby the light reducing performance is equivalent to approximately 3,4 EV. It is desirable that the slit 55 has a shape to widen its cross-section to the subject side (in an arrow direction) as shown in FIG. 9 not to prevent spread of light.

The operation of the above construction is explained now. When the daylight photography, which does not require flash emission, is taken outdoors in sunny days, the operation member 15 is slid down in the operation opening 14 to select the first photography mode as the first operational position as shown in FIG. l.

When the operation member 15 is set in the first operational position, the movable stop plate 46 is set in the insertion position by the stop changeover mechanism 36 and the small stop aperture 46a is disposed on the optical axis of the taking lens 5. The shutter speed changeover mechanism 37 restricts the shutter blade 40 to reduce its rotating angle. The flash switch 31 is turned off. Consequently, in the first photography mode, photographs are taken with 1/140 seconds of the high shutter speed, f/14 of the small aperture size and without flash emission.

When flash emission is required for photography outdoors in sunny days, for example against the sun, the operation member 15 is slid up in the operation opening 14 to select the second photography mode as the second operational position as shown in FIG. 2. When the operation member 15 is set to the second photography mode, same shutter speed and stop aperture as the first photography mode are set while the flash switch 31 is turned on. Therefore, in the second photography mode, photographs are taken with 1/140 seconds of the high shutter speed, f/14 of the small aperture size and with flash emission. Since the light reducing plate 19 is not disposed in front of the flash emitter 7 in the second photography mode, flash light emitted from the flash emitter 7 illuminates the subject without reducing its amount.

In a photographing of a main subject such as a person while reproducing a background at a proper density, the flash operation member 15 is rotated to the third operational position from the second operational position to select the third photography mode. When the third photography mode is selected, the movable stop plate 46 is set in a retreat position to cancel the restriction of the shutter blade 40 by the shutter speed changeover mechanism 37. And the light reducing plate 19 is slid to the light reducing position from the retreat position to be positioned in front of the flash emitter 7, and the indication plate 20 projects from below to in front of the viewfinder 6.

In the third photography mode, since restriction of the shutter blade 40 for reducing its rotating angle is cancelled, photographs are taken with 1/45 seconds of the low shutter speed, f/5.6 of the large aperture and with flash emission. In the third photography mode, since the light reducing plate 19 is positioned in front of the flash emitter 7, only flash light emitted from the flash emitter 7 and passing thorough the slit 55 illuminates to the subject, thereby photographs are taken with appropriate amount of flash emission for the large aperture, such that brightness between the main subject and the background becomes small. In addition, the flash light can be illuminated with preferable pattern of light distribution since the slit 55 extends perpendicular to the longitudinal direction of the flash discharge tube 51.

Next, a second embodiment is explained now. In this embodiment, the present invention is applied to a lens-fitted photo film unit having a close-up mode. This embodiment is similar to the first embodiment except for that a third photography mode is a close-up mode in which an aperture value and a position of a slit on a light reducing plate are different from the first embodiment, therefore the same or substantially same parts as those of the first embodiment will be designated by the same reference numerals, so the detailed description of these parts will not be repeated.

In the third photography mode, flash light is reduced by the light reducing plate 19. This light reducing prevents a subject from being overexposure, so called white out, in the close-up photography. Table 2 shows one example of a shutter speed, an aperture value, with or without flash emission, and a guide number in each photography mode. In the third photography mode of this example, the stop changeover mechanism 36 is constituted so as to insert the small aperture of f/22 onto the optical axis of the taking lens 5.

TABLE 2

| | | SHUTTER | | LIGHT | GUIDE |
|---|---|---|---|---|---|
| | APERTURE | SPEED | | REDUCING | NUMBER |
| | VALUE | (Sec) | FLASH | PLATE | (ISO100 · m) |
| 1st PHOTOGRAPHY MODE | f/14 | 1/140 | OFF | NO | — |
| 2nd PHOTOGRAPHY MODE | f/14 | 1/140 | ON | NO | 8.8 |
| 3rd PHOTOGRAPHY MODE | f/22 | 1/45 | ON | YES | 2.7 |

In FIG. 10, the light reducing plate 19 is provided with a slit 58. The slit 58 is long and thin and is provided perpendicular to the longitudinal direction of the flash discharge tube 51 such that a center of the slit 58 is located toward the taking lens 5 from a center of the flash discharge tube 51 in the longitudinal direction. The distance “d” between the center of the flash discharge tube and that of the slit is shown in the figure. This configuration is designed by utilizing the fact that an exposure range of flash light is off to the side when the slit is located off the center of the flash discharge tube 51 in the longitudinal direction. Therefore, if the slit 58 is located nearer the taking lens 5, the exposure range of flash light is corrected to coincide with the image taking field in the close-up mode.

Next, a third embodiment that a light reducing plate is provided to an close-up adaptor is explained now. In a lens-fitted photo film unit 60, a close-up adaptor 62 is attached to a front face of a unit body 61. A fixed-focal taking lens 63 of which focus range is 1 m to infinity, is used in the lens-fitted photo film unit 60. When a flash operation member 64 is slid up to set to ON position, flash light is emitted from a flash emitter 7 in synchronization with the photographing.

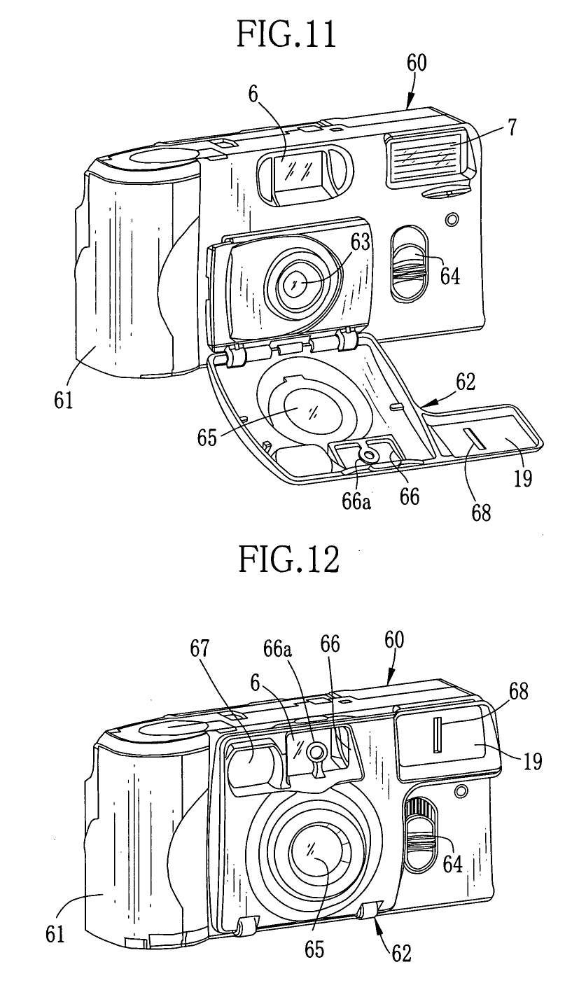

The close-up adaptor 62 is attached to the unit body 61 in a rotatable manner so that an auxiliary lens 65 for close-up mode (hereinafter referred to as the auxiliary lens) is shifted between a retreat position to be retreated from in front of the fixed focal lens 63 shown in FIG. 11 and a set position in front of the fixed focal lens 63 shown in FIG. 12. Moreover, the close-up adaptor 62 may be detachable to the unit body 61.

The auxiliary lens 65 is a close-up lens for changing focal position by combining with the taking lens 63 as a main lens. The changed focal position is in a range of, for example, 40 to 80 cm.

The close-up adaptor 62 is provided with a close-up finder 66 and a mirror 67. In the close-up photograph, the close-up finder 66 limits view range of the finder 6 to correct parallax (azimuth difference) between the viewfinder 6 and the taking lens 63. A target ring 66a showing a central position of the image taking field is positioned in the close-up finder 66. On camera framing, a main subject is easily taken in a center of a frame by positioning the main subject to the center of the target ring 66a.

The mirror 67 is used for confirming that a user oneself is within a view angle when the user photographs oneself. The mirror 67 is formed with a convex mirror, and its direction and curvature of the convex face is determined so that the subject positioned within the image taking field in the close-up photography can be displayed.

The light reducing plate 19 is integrally provided in the close-up adaptor 62. The light reducing plate 19 is positioned in front of the flash emitter 7 when the close-up adaptor 62 is set to the set position. The light reducing plate 19 is provided with a slit 68 in a similar manner to the second embodiment that the slit 68 is positioned toward the taking lens 63 from the center of the flash discharge tube 51 in the longitudinal direction.

In the lens-fitted photo film unit 60, when a person or a view is photographed with distance of equal to or more than 1 m, the photograph is taken in a manner that the close-up adaptor 62 is set in a retreat position as shown in FIG. 11. When the flash operation member 64 is slid up to ON position, flash light emitted from the flash emitter 7 illuminates the subject without reducing its light amount in synchronism with photographing.

In macro photography such as a self-photograph, a flower or a plant photograph, the photograph is taken in a manner that the close-up adaptor 62 is set to the set position. In the set position, the auxiliary lens 65 is positioned in front of the taking lens 63 to change the focal position to a short distance side, for example 40 to 80 cm of focal distance, so the photograph in which the short-range subject is in focus can be taken.

When the photograph is taken with flash emission in the manner that the close-up adaptor 62 is set to the set position, the flash operation member 64 is slid up to the ON position. In this case, since flash light passed through the slit 68 on the light reducing plate 19 illuminates the subject, overexposure is prevented. Moreover, since the slit 68 is located slightly toward the taking lens 5, illumination range of flash light is corrected so that the image taking field for short-range photographing with use of the close-up adaptor 62 is almost covered, thereby unevenness of exposure does not occur.

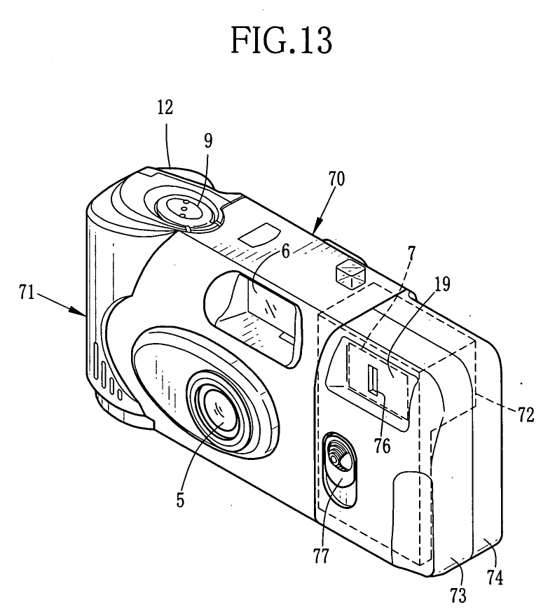

FIG. 13 shows a fourth embodiment in which a light reducing plate is integrally provided in a front cover of a lens-fitted photo film unit. A lens-fitted photo film unit 70 has a unit body 71 with built-in various photographic mechanisms, a stop changeover mechanism, a shutter speed changeover mechanism, a flash device 72 and a film cartridge. The unit body 71 has a front cover 73 and a rear cover 74 covering front and rear of a body base to which various mechanism and parts are attached. A light reducing plate 19 is integrally provided on a portion of the front cover 73 facing the flash emitter 7 of the flash device 72. The light reducing plate 19 is formed with a long and thin slit 76 perpendicular to a longitudinal direction of a flash discharge tube.

When a flash operation member 77 slidable in a vertical direction is set to OFF position (lower position), a first photography mode whose conditions are a small aperture, a high shutter speed, and with flash emission, is set. When the flash operation member 77 is set to ON position (upper position), a second photography mode whose conditions are a large aperture, low shutter speed, and with flash emission, is set. In the second photography mode, the flash light is reduced by the light reducing plate 19 integrally provided and fixed to the front cover 73. Table 3 shows one example of an aperture value, a shutter speed, with or without flash emission, and a guide number in each photography mode.

TABLE 3

| | | SHUTTER | | LIGHT | GUIDE |
|---|---|---|---|---|---|
| | APERTURE | SPEED | | REDUCING | NUMBER |
| | VALUE | (Sec) | FLASH | PLATE | (ISO100 · m) |
| 1st PHOTOGRAPHY MODE | f/14 | 1/140 | OFF | YES (FIXED) | — |
| 2nd PHOTOGRAPHY MODE | f/5.6 | 1/45 | ON | YES (FIXED) | 2.7 |

In this embodiment, the second photography mode, for example, in which a small amount of flash light is emitted from a reused flash device with a large amount of light, can be actualized.

As described above, the light reducing plate is desirably achromatic colors such as gray or black for preventing coloring flash light. Therefore, design (color) of the front cover is limited if the front cover and the light reducing plate are integrally formed as mentioned in the fourth embodiment. Then, the light reducing plate may be separated from the front cover and attached to the front of the flash emitter.

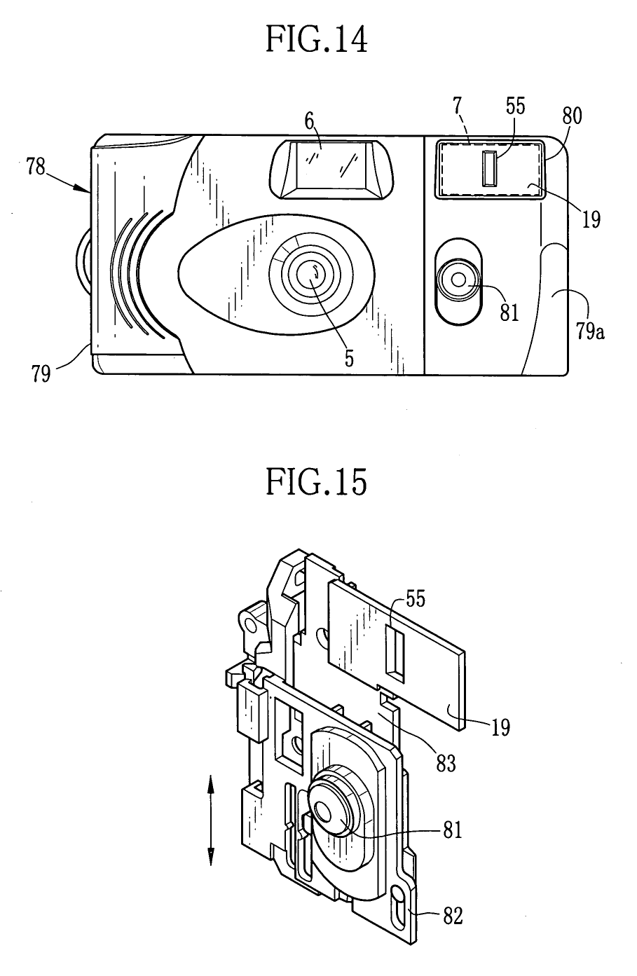

A fifth embodiment in FIGS. 14 and 15 shows that a light reducing plate is integrally provided on a backing plate which slidably supports an operation member. As shown in FIG. 14, a lens-fitted photo film unit 78 has a unit body 79 with built-in photographic mechanisms, a stop changeover mechanism, a shutter speed changeover mechanism, a flash device and a film cartridge. A front cover 79a is provided with an opening 80 for exposing the flash emitter 7. The light reducing plate 19, provided with a slit 55 and disposed in front of the flash emitter 7 is located in an opening 80.

A flash operation member 81 is slidable in a vertical direction, and when the operation member 81 is set to OFF position as shown in FIG. 14, a first photography mode whose conditions are a small aperture, a high shutter speed and without emission of flash light, is set. When the flash operation member 81 is slid up to ON position, a second photography mode whose conditions are a large aperture, low shutter speed and with emission of flash light, is set. It is noted that this embodiment is same as the fourth embodiment regarding the aperture value, the shutter speed and the guide number.

As shown in FIG. 15, the flash operation member 81 is integrally provided on a slide plate 82, and the slide plate 82 is slidably attached to a backing plate 83. The light reducing plate 19 is formed on an upper portion of the backing plate 83 and the backing plate 83 is fixed in the unit body 79. Therefore, the light reducing plate 19 is positioned in front of the flash emitter in all photography modes. Since the backing plate 83 is not exteriorly exposed, there is no influence on design, even when the backing plate 83 is colored same achromatic colors such as gray or black as the light reducing plate 19.

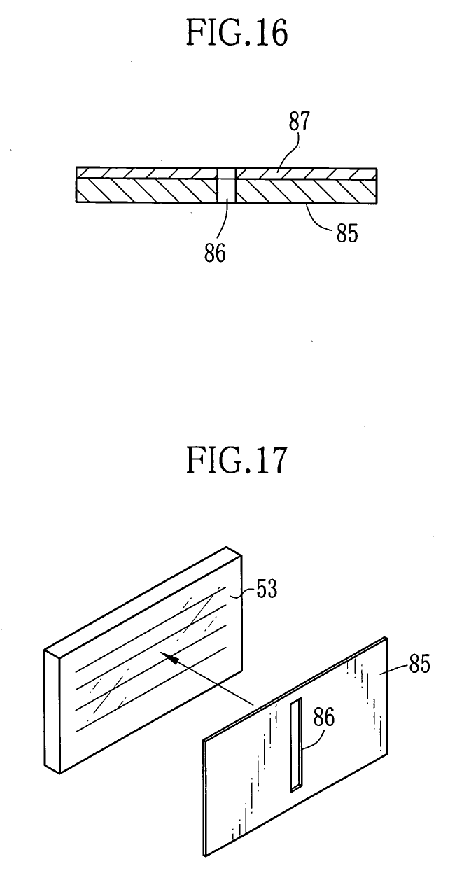

FIGS. 16 and 17 show a sixth embodiment in which a light reducing plate is pasted to a protector as a sticker. A light reducing plate 85 is formed in a sheet shape which has same size or slightly bigger than a protector 53 of a flash emitter. The light reducing plate 85 is formed with a slit 86 similar to that of the above embodiments. An adhesion layer 87 is formed on one face of the light reducing plate 85 to paste the light reducing plate 85 to a front face of the protector 53. Detachable adhesive compound may be used for the adhesion layer 87, such that the shielding plate 85 may be removed after pasting it and pasted it again.

According to this embodiment, it may be possible to adjust light amount of flash light to have an appropriate pattern of light distribution by only pasting the light reducing plate 85 to the protector 53, without exchanging a main capacitor or other parts of a flash device. Therefore, flash devices having common specification can be used for flash devices for emitting various amounts of light, so it is possible to standardize the parts and to effectively utilize reused flash devices.

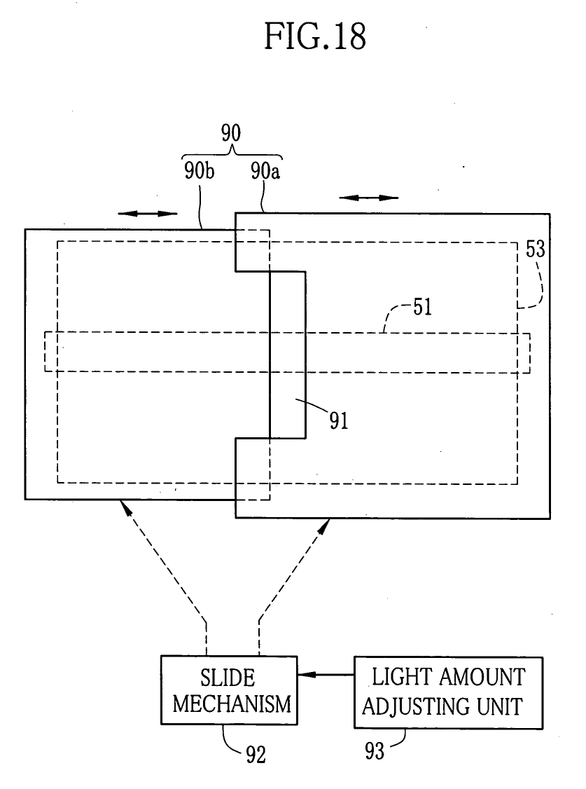

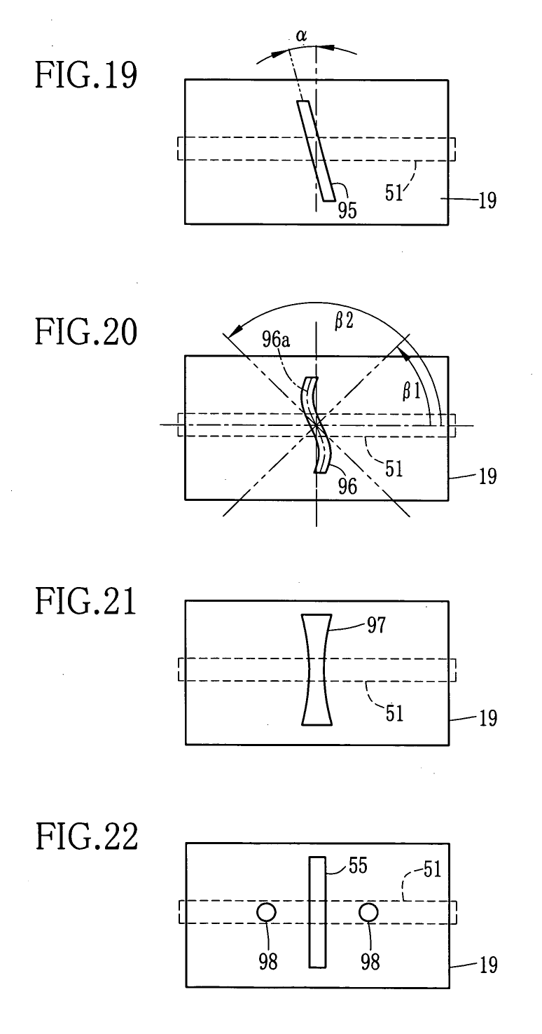

FIG. 18 shows a seventh embodiment in which an opening width of a slit is changeable. According to this embodiment, a light reducing plate 90 disposed in front of the flash emitter 7 includes a pair of slide members 90a and 90b. The slide member 90a is provided with a “U-shape” cutout, and the cutout is partially overlapped to the slide member 90b to form a long and thin rectangular slit 91 in a perpendicular direction of the flash discharge tube 51.

A slide mechanism 92 slides the slide members 90a and 90b in an opposite direction each other along a longitudinal direction of the flash discharge tube 51 by operation of a light amount adjusting unit 93. Consequently, it is possible to change an opening width of the slit 91 by operation of the light amount adjusting unit 93 to adjust light reducing performance of the light reducing plate 90.

The position of the slit 91 may be changed by sliding the slide members 90a and 90b in an identical direction each other. Moreover, the opening width of the slit 91 may be changed in addition to changing the position thereof. The light amount adjusting unit 93 may be operated interacting with other operation members or may be used with an operation member for selecting photography modes.

As described above, although the slit formed on the light reducing plate is preferably a long and thin rectangle disposed perpendicular to the longitudinal direction of the flash discharge tube, the slit may be slightly tilted to the direction perpendicular to the longitudinal direction of the flash discharge tube 51, for example, shown as a slit 95. Problems do not arises much in a manner that the angle a between the direction perpendicular to the longitudinal direction of the flash discharge tube 51 and the slit 95 is within a range of 0° to 45°, but it is preferable to avoid the angle over 45° since the light distribution is worsen.

Moreover, the shape of the slit may be curved, for example, as a slit 96 shown in FIG. 20. In this case, a centerline 96a of the slit 96 is desirably located in the range of 45° (=β1) to 135° (=β2) which is intersecting angle with the longitudinal direction of the flash discharge tube 51.

Furthermore, as shown in FIG. 21, the widths of both ends 97a of a slit 97 are preferably wider than that of the center part thereof. Consequently, it is possible to emit appropriate amount of flash light to the peripheral part of the frame which is likely to lack light amount. Still furthermore, an auxiliary opening 98 may be provided in the light reducing plate in addition to the slit 55 for improving design and fine adjustment of light amount. The number of the auxiliary openings 98 is preferably one or more, in which as amount of flash light emitted through the auxiliary openings 98 is at least 1.0 EV smaller than that emitted through the slit, and the opening size of the auxiliary openings 98 is preferably equal to or less than 25% of the slit.

Although the lens-fitted photo film unit, in which an amount of flash light is reduced, is explained, the present invention is applicable to a flash device built in a camera capable of reloading a photo film, or a flash device used in a manner to be mounted to the camera.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A flash light reducing plate for reducing flash light emitted from a flash emitter to illuminate a subject, said flash emitter including a flash discharge tube for emitting said flash light, said flash light reducing plate comprising:
a light shielding portion for shielding said flash light; and
a slit for allowing passage of said flash light, said slit being formed in said light shielding portion and being located in front of an almost center part of said flash discharge tube, and extended in a direction almost perpendicular to a longitudinal direction of said flash discharge tube.

2. A flash light reducing plate according to claim 1, wherein both end portions of said slit have a width wider than a central portion thereof.

3. A flash light reducing plate according to claim 1, wherein an amount of said flash light is reduced equivalent of equal to or more than 3.0 EV.

4. A flash light reducing plate according to claim 1, wherein said light shielding portion further has an auxiliary opening whose size is smaller than that of said slit.

5. A flash light reducing plate according to claim 1, wherein said light shielding portion is adhered to a surface of said flash emitter.

6. A flash light reducing plate according to claim 1, wherein said flash light reducing plate is movable between a light reducing position to be positioned in front of said flash emitter and a retreat position to be retreated from in front of said flash emitter.

7. A flash light reducing plate according to claim 1, wherein an opening width of said slit is adjustable.

8. A lens-fitted photo film unit preloaded with an unexposed photo film, comprising:
a flash emitter for emitting flash light from a flash discharge tube to a subject; and
a flash light reducing member for reducing flash light emitting from said flash emitter to illuminate a subject, said flash light reducing member including a light shielding portion for shielding said flash light and a slit for allowing passage of said flashlight, said slit being formed in said light shielding portion and being located in front of an almost center part of said flash discharge tube and extended in a direction almost perpendicular to a longitudinal direction of said flash discharge tube.

9. A lens-fitted photo film unit according to claim 8, wherein both end portions of said slit have a width wider than a central portion thereof.

10. A lens-fitted photo film unit according to claim 8, wherein said flash light reducing member reduces an amount of said flash light equivalent of equal to or more than 3.0 EV.

11. A lens-fitted photo film unit according to claim 8, wherein said flash light reducing member further has an auxiliary opening whose size is smaller than that of said slit.

12. A lens-fitted photo film unit according to claim 8, further including:
an external operation member for selecting either a normal mode which does not reduce said flash light or a light reducing mode which reduces said flash light; and
a moving mechanism for moving a flash light reducing member interlocking with mode selection of said external operation member, said moving mechanism retreating said flash light reducing member from in front of said flash emitter when said normal mode is selected, and setting said flash light reducing member to in front of said flash emitter when said light reducing mode is selected.

13. A lens-fitted photo film unit according to claim 8, further including:
a body base containing said photo film;
photographic mechanisms attached to said body base;
a rear cover attached to a rear of said body base; and
a front cover attached to said body base to cover said body base and photographic mechanisms, said flash light reducing member being integrally provided to said front cover.

14. A lens-fitted photo film unit according to claim 8, wherein said slit is shifted toward a taking lens from a center of said flash discharge tube.
